(19) United States
(12) Patent Application Publication
(10) Pub. No.: US 2004/0025905 A1
(43) Pub. Date: Feb. 12, 2004

(54) Method for unpacking shaped bodies embedded inside unbound particle material

(76) Inventors: Ingo Ederer, Pflaumdorf (DE); Bernhard Graf, Landsberg (DE)

Correspondence Address: DOBRUSIN & THENNISCH PC, 401 S OLD WOODWARD AVE, SUITE 311, BIRMINGHAM, MI, 48009, US

(21) Appl. No.: 10/381,547

(22) PCT Filed: Oct. 4, 2001
(86) PCT No.: PCT/DE01/03834

(30) Foreign Application Priority Data
Oct. 4, 2000 (DE) 100 49 043 .3

(51) Int. Cl. B08B 7/00

(52) U.S. Cl. 134/6; 134/21; 15/300.1; 15/160

(57) ABSTRACT

Described herein is a method for breaking out a pattern (1) embedded in loose particulate matter (2), whereby the pattern (1) is arranged on a platform (4) movable at least vertically. At least during breakout, the movable platform (4) is enclosed in a container (3) that is open at least in the upward direction as viewed from the platform (4) towards the pattern (1). The platform (4) is displaced at the desired settable speed upwards in the direction of the pattern (1) and the loose particulate matter (2) is removed simultaneously.

This invention relates to a method and a device for breaking out a pattern embedded in loose particulate matter, whereby the pattern is arranged on a platform movable at least vertically, which at least during breakout is enclosed in a container that is open at least in the upward direction as viewed from the platform towards the pattern.

Several methods are known for rapid production of geometrically complicated three-dimensional objects with undercuts that can be produced without primary moulding tools, i.e. without the actual inner and outer physical shape of the object as either a positive or a negative pattern, and also without any need for machining and/or non-mechanical removal, whereby such methods can build the desired objects directly from the computer generated three-dimensional geometric representation. The base material used here could be a solid, a particulate matter, or a fluid.

These methods known as generative manufacturing, rapid prototyping, solid free-form manufacturing, or fast free-form fabrication are being applied ever more often. The most well known methods among these are stereo lithography, laser sintering, and the method for building casting patterns from moulding sand, casting resins, and curing agents.

Rapid prototyping in particular typically employs a particulate matter, namely moulding sand, to build castings.

In such a rapid prototyping method, a loose particulate matter like moulding sand is deposited and spread out over a platform on which the workpiece or pattern is to be built, and this is then sintered only at the appropriate spots, for instance, through selective laser sintering.

Also when building castings from moulding sand, casting resins and curing agents, the moulding sand is first deposited on the platform and then the casting resin on top of that, followed by the application of a curing agent at just the appropriate spots to be hardened, i.e. only where the moulding sand is to be bonded.

On completion of the building process, the pattern is embedded within a loose bed of sand, since the sand was deposited all over the platform on which the pattern is built, rather than just selectively. Once the pattern is finished, it must be removed from the particulate matter or sand bed, and the loose sand cleared from the pattern.

Accordingly it is also known that the powder material and pattern are broken out directly in the pattern building device.

In the European patent EP 0 968 776 it is accordingly described that the completed casting is removed from the surrounding loose sand bed when the building process is finished. Any loose moulding sand in the pattern's interior is sucked, shaken, or blown out through the filling port and/or through the openings specially intended for removing such sand.

From the U.S. Pat. No. 5,902,441 it is further known that finished patterns are scooped out of the loose sand bed and any sand not clinging to the pattern is removed using compressed air or a vacuum.

Furthermore, it is common in practice to empty out the pattern and any excess particulate matter on a table and to then remove the pattern.

All of these methods for breaking out patterns have the disadvantage that the patterns often get damaged during removal, resulting in the need for rework or possibly even rebuilding, which lead to higher manufacturing costs.

The method disclosed in U.S. Pat. No. 5,814,161 involves the removal of loose powder from the outer and inner surfaces of patterns, especially ceramic patterns. This method utilizes a bath of water charged with CO₂. The particular pattern with cavities blocked by loose powder is immersed in this water bath and the pressure is then dropped rapidly. In this way, water that flows into the powder material begins to bubble with the release of the entrained CO₂, thereby ejecting out loose powder from the cavities.

This is, however, a relatively complicated method that is also very costly.

Furthermore, it is known from practice that a pattern embedded in loose powder or particulate matter is broken out in such a way that a synthetic cylinder is laid on top of a platform on which pattern is built. The platform is then moved into its upper position towards the synthetic cylinder, and all the powder and the pattern are thereby inserted into the cylinder.

An appropriately large spatula is then slid between the cylinder and the building level, and the cylinder is raised out of the device with this spatula and placed on a screening unit. As the cylinder is now raised upwards, the pattern falls out and lies in the powder pile, which spreads out over the screen and trickles slowly through it into a receiving pan.

This method too has been found to be relatively complicated. Besides, with such a procedure breaking out large patterns or those with some undercuts is very difficult, since the patterns can tilt and become damaged through the breakout procedure.

Another breakout procedure known is currently practiced, whereby the platform is raised to its upper stop in the direction of the built-up pattern. However, this causes the loose and unconsolidated powder to spread out over the whole platform. After being raised, the pattern must then be dug out of the powder.

Breaking out is sometimes done such that a job box enclosing a pattern is removed from the pattern building device and the job box is then emptied out. For this purpose, either the container wall is opened, or the building platform is taken out downwards. The excess powder flows out through the opening formed when the container is either opened or lowered. However, all of the breaking out methods known so far have the disadvantage that they are relatively complicated and thereby costly, and can often cause damage during breakout of especially large patterns or patterns with many undercuts.

Hence, it is the object of this invention to provide a method for breaking out patterns embedded in loose particulate matter, whereby the method makes it possible to easily release even large and complicated patterns after they are manufactured, from loose and unconsolidated particulate matter.

According to the invention, this requirement is fulfilled with a method of the aforementioned type, in that the movable platform is displaced at the desired settable speed upwards in the direction of the pattern and the loose particulate matter is removed simultaneously.

With a method according to the invention, it is now possible that, depending on the complexity and size of the part involved, the operator can adjust and set the upward motion precisely to enable removal of the particulate matter. For example, the movement steps and/or the speed could be set independently.

For the purposes of completeness, it should be mentioned that the removal process could be done equally well either manually or with a machine.

With simple patterns that are embedded in loose particulate matter and can be placed steadily on a platform, the upward movement of the platform can be at a higher speed, whereas for complicated patterns or those with significant overhangs, a slower upward movement speed is used.

It has been found to be particularly advantageous, if the platform is moved stepwise. A design of this type makes it possible for the operator to not have to remove the loose particulate matter during movement of the platform, but instead allows the platform to be moved up a little at a time and stopped for removing the particulate matter, and then moved another step upwards and so on.

The loose particulate matter can, for example, be vacuumed away. It is just as feasible that the removal is done by swept away or also with the assistance of a brush, a spoon, or compressed air.

Especially in situations where the pattern has major overhangs extending beyond its base, it has been found to be advantageous if the removal of the loose particulate matter is done only at the upper portions of the pattern, leaving the overhangs supported with the remaining sand until the entire pattern has been released.

If the platform is in its uppermost position, the pattern can be lifted as usual from the platform or, if desired, left on the platform and the entire unit scooped out for pouring and transportation to the relevant location.

In a method according to the invention, since the pattern remains on the platform until the end, it is also possible to mount reinforcements on the pattern or the platform. In this way, for example, support frames could be attached with an adhesive or otherwise, or dowels could also be installed for eyelets, thereby providing even more stability for the pattern to be built.

This type of a frame could also have an additional support for turning, with which the pattern could be lifted from the platform and turned to be able to build a cope, for instance.

In a device according to the invention for breaking out a pattern embedded in loose particulate matter, arranged on a platform movable at least in the vertical direction, whereby for the breakout the movable platform has at least a container around it that is open at least in the upward direction as viewed from the platform towards the pattern, such a container is provided with at least a grating arranged around it.

Since the device, for instance, is arranged on a type of pedestal, such that a grating can be arranged around the device to allow the sand to fall through the grating instead of on to the floor, the workspace around the device can be kept clean more easily, and any encroachment by the operator can also be minimized.

It has been found to be particularly advantageous if the breakout is conducted according to the previously described method, since the operator needs to be able to get around the pattern for removing as much of the particulate matter therefrom as possible.

Since the removal occurs in the breakout device, it is especially important that the device have a grating arranged around it.

The device according to the invention can be cleaned very easily, especially if the grating has drawers underneath for collecting the loose particulate matter, which drawers can be pulled out and emptied.

If, for example, the platform is transported over a roller conveyor, it can be attached and integrated easily into a system for producing patterns. This makes it possible, for instance, to use the roller conveyor to load the platform into a device for building patterns, to build the pattern, to move the device with a roller conveyor into a breakout device or breakout station according to the invention, and to subsequently transport it perhaps directly after the breakout for pouring, and that too on a roller conveyor.

However, such an arrangement is not absolutely necessary, but instead it is also conceivable to integrate the device according to the invention directly into the device for building patterns.

If at least one roller conveyor is used for motion, at least one step deck should be built across the roller conveyor to make it easier for the operator to access the entire workpiece platform.

A preferred embodiment of the invention has at least one operating console with which the platform can be moved at the desired speed. This operating console should be easily accessible and simply outfitted, ideally with pushbuttons for UP, DOWN, FULL DOWN, FULL UP, and STOP actions.

It is especially advantageous when at least two sides of the device have an operating console each for moving the platform.

Additional advantages and advantageous arrangements of the subject matter of the invention become apparent from the following drawings depicting an example of an embodiment described in principle, in which:

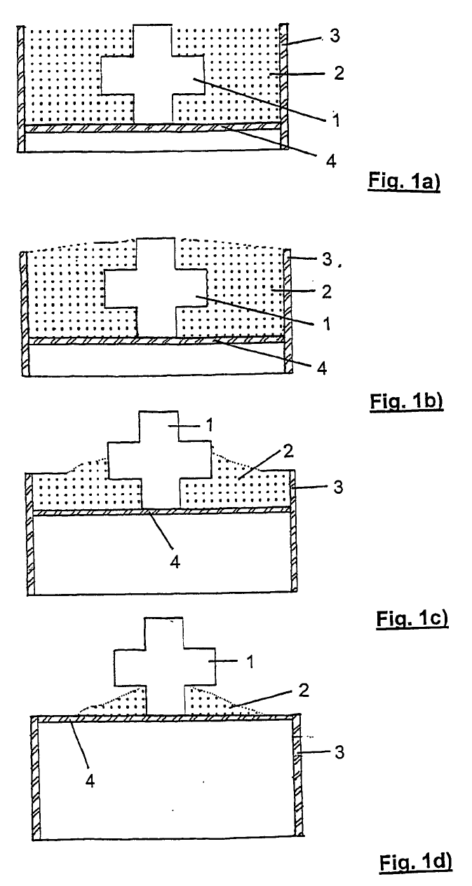

FIG. 1 is a schematic representation of the sequence of operation of the method in a preferred embodiment of the invention;

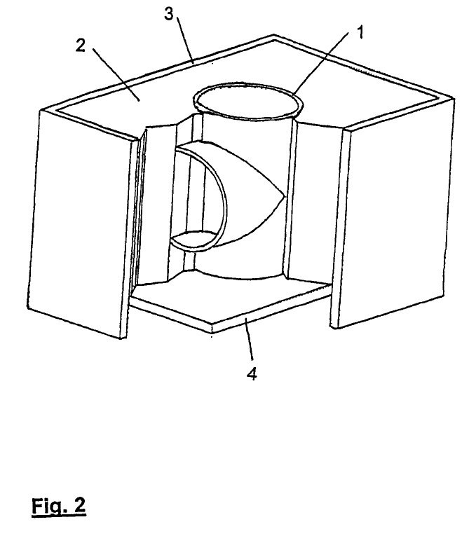

FIG. 2 is a partial sectional view of a pattern embedded in loose particulate matter;

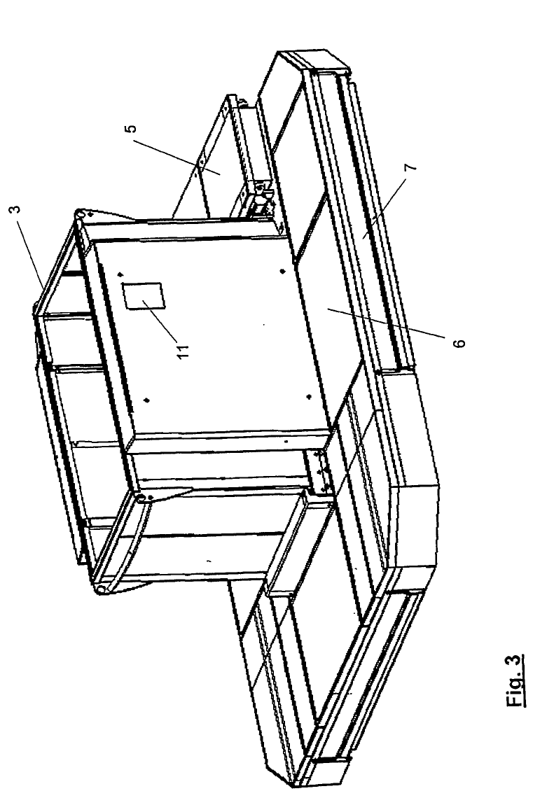

FIG. 3 is a preferred embodiment of the device according to the invention, and

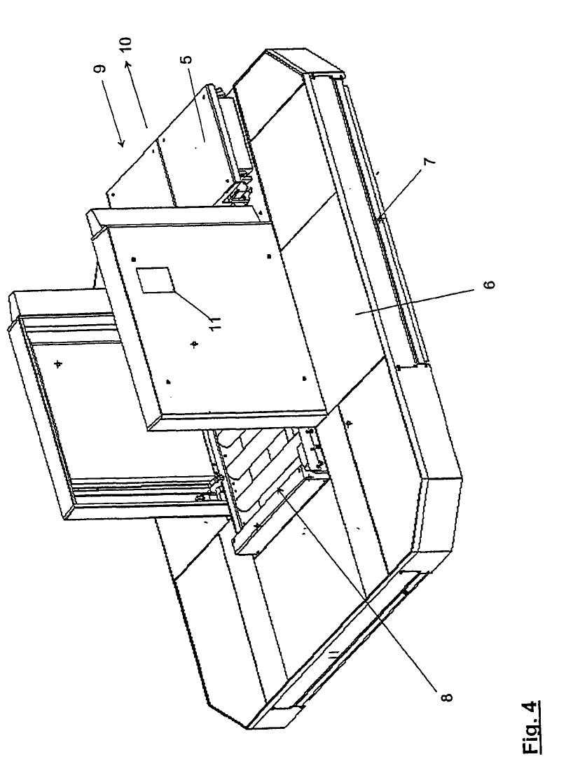

FIG. 4 is a device according to FIG. 3, whereby the container containing the pattern and the platform are not shown for reasons of clarity.

FIG. 1 depicts breaking out of pattern 1 in steps. Accordingly, platform 4, container 3, and pattern 1 are shown in a sectional view. Pattern 1 is embedded in loose particulate matter 2. The pattern 1 would be embedded in this type of loose particulate matter, if it were manufactured according to a typical rapid prototyping method. As an example, the pattern manufacturing mentioned here is from moulding sand, casting resins, and curing agents.

According to the preferred embodiment shown, this pattern 1 embedded in loose particulate matter 2 is arranged in a so-called job box formed by platform 4 and container 3. The pattern 1 is also built-up in such a job box, whereby platform 4 within container 3 can be moved at least in the vertical direction, which can also occur during pattern building.

According to the invention, for breaking out pattern 1 movable platform 4 is displaced at the desired settable speed upwards in the direction of pattern 1, and the loose particulate matter 2 is removed simultaneously.

FIGS. 1a) through id) show various stages of the upward movement process of movable platform 4. As shown in particular in FIGS. 1c) and id), while moving upwards or if the upward movement process occurs stepwise, also when at a standstill during the upward movement process, the loose particulate matter 2 is repeatedly removed through brushing, vacuuming, or with the assistance of compressed air.

The pattern 1 in FIG. 1 is illustrated as a sectional view of a cross-shaped pipe, built in a previous work stage. In order that this cross-shaped pipe remains stable on platform 4, also when moved upwards, loose particulate matter is left in place under the lateral pipe parts until the end, as shown distinctly in FIG. 1d).

When platform 4 is at its uppermost position as depicted in FIG. 1d), the cross-shaped pipe can be simply lifted from platform 4.

To illustrate this better, FIG. 2 again represents the job box containing pattern 1 in a three-dimensional, partly sectioned view. This pattern 1 is covered by loose particulate matter 2 and enclosed within container 3, which is open when looking upwards from workpiece platform 4 in the direction of pattern 1.

As shown in FIG. 2, a mainly right-angled container 3 and its respective platform 4 are preferred. However, this is not absolutely necessary, since it is quite conceivable that both container 3 and platform 4 could have any other imaginable shape.

FIG. 3 depicts a device according to the invention just as FIG. 4, whereby container 3 and platform 4 are not shown for reasons of clarity in FIG. 4.

According to the preferred embodiment shown, container 3 is utilized during the building of pattern 1. However, this is not absolutely necessary, since container 3 could be one that had been installed just prior to the breakout.

FIG. 3 also depicts container 3 arranged with grating 6, whereby drawers 5, which can be taken out easily, are arranged under the grating for collecting the loose particulate matter 2.

As shown in particular by FIG. 4, according to the preferred embodiment depicted platform 4 is transported over a roller conveyor 8. This enables workpiece platform 4 to be moved into the breakout device, with or without container 3. This can be achieved with roller conveyor 8 running either through the device or entering it from just one direction only.

According to the preferred embodiment illustrated, roller conveyor 8 does not go all the way straight through the device up to the breakout device. The loading direction is indicated in FIG. 4 by arrow 9 and the unloading direction by arrow 10. Therewith, according to the invention, platform 4 would be loaded and again unloaded into the device from the same side.

According to the invention, on the side of the device where roller conveyor 8 goes in, a step deck 5 is provided across roller conveyor 8 to ensure the best access for the operator. This step deck 5 is, for example, split in two such that it can be folded away from roller conveyor 8 to the left and right, when platform 4 needs to be moved out of the device.

The box 11 in FIGS. 3 and 4 represents a schematic view of an operating console 11 for raising and lowering platform 4. On the other side of the device is also a mirror image of such an operating console, such that the operator can easily reach one of the two operating consoles 11 in every possible position for removing the loose particulate matter 2.

### List of Referenced Numbers

1 Pattern

2 Loose Particulate Matter

3 Container

4 Platform

5 Step Deck

6 Grating

7 Drawer

8 Roller Conveyor

9 Loading Direction

10 Unloading Direction

11 Operating Console

1. A method for breaking out a pattern embedded in loose particulate matter, whereby the pattern is arranged on a platform movable at least vertically, which at least during breakout is enclosed in a container that is open at least in the upward direction as viewed from the platform towards the pattern,
characterised in that
the platform (4) is displaced at the desired settable speed upwards in the direction of the pattern (1) and the loose particulate matter (2) is removed simultaneously.

2. The device according to claim 1,
characterised in that
the displacement of the platform (4) occurs stepwise.

3. The device according to claims 1 or 2,
characterised in that
the loose particulate matter (2) is removed through vacuuming.

4. The device according to one of the foregoing claims,
characterised in that
the loose particulate matter (2) is removed through brushing.

5. The device according to one of the foregoing claims,
characterised in that
the loose particulate matter (2) is removed only from above the pattern (1).

6. A device for breaking out a pattern embedded in loose particulate matter, whereby the pattern is arranged on a platform movable at least vertically, which at least during breakout is enclosed in a container that is open at least in the upward direction as viewed from the platform towards the pattern, especially for application in a method according to one of the foregoing claims,
characterised in that
the container (3) has a grating (6) arranged at least partially around it.

7. The device according to claim 6,
characterised in that
under the grating (6) are drawers (7) for collecting the loose particulate matter (2).

8. The device according to claims 6 or 7,
characterised in that
the platform (4) is transported on at least one roller conveyor (8).

9. The device according to claim 8,
characterised in that
at least one step deck (5) is arranged across the roller conveyor (8).

10. The device according to claims 6 to 9,
characterised in that
at least one operating console (11) is provided to enable the platform (4) to be displaced at the desired settable speed.

11. The device according to claims 6 to 10,
characterised in that
an operating console (11) for displacing the platform (4) is provided on at least two sides of the device.
